(19) United States
(12) Patent Application Publication
(10) Pub. No.: US 2003/0192384 A1
(43) Pub. Date: Oct. 16, 2003

(54) In-mold pressure verification device

(75) Inventor: Raffaello Verna, Creedmoor, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Troxler Electronic Laboratories, Inc.

(21) Appl. No.: 10/121,095

(22) Filed: Apr. 11, 2002

(51) Int. Cl. G01N 3/08

(52) U.S. Cl. 73/824

(57) ABSTRACT

A pressure verification device is provided which is configured to be used with a Superpave gyratory compactor to measure the pressure applied to a specimen of asphalt paving mix during the compaction process. The pressure verification device is positionable within the cylindrical mold of the gyratory compactor for dynamically measuring the pressure exerted upon the sample within the mold. The pressure verification device comprises a rigid disk-shaped plate having opposing surfaces, with at least one pressure transducer being carried by the disk-shaped plate on one of the opposing surfaces.

### FIELD OF THE INVENTION

The invention relates to a device for measuring pressure, and more particularly to a device for verifying the pressure in a Superpave gyratory compactor.

### BACKGROUND OF THE INVENTION

The Strategic Highway Research Program (SHRP) has developed a standard for testing the physical properties of a bituminous asphalt paving mix, using a device known as the Superpave gyratory compactor. The Superpave gyratory compactor produces compacted cylindrical test specimens of the asphalt paving mix for determining volumetric and mechanical properties. The compactor simulates the kneading action of the large rollers used to compact asphalt pavement during highway construction. A specimen of the asphalt paving mix is placed in an open-ended cylindrical mold, with circular disks or plugs being placed at opposite ends of the mold. The gyratory compactor device applies pressure to the specimen in the mold while gyrating the mold at a specified angle to produce a gyratory kneading action. The Superpave gyratory compactor specifications call for the mold to be gyrated at a compaction angle of 1.25 degrees operating at 30 rpm while applying a consant pressure of 600 kPa.

Several manufacturers produce gyratory compactors according to the Superpave gyratory compactor specifications. Gyratory compactors of this type are described for example in the following U.S. Pat. Nos. 5,323,655; 5,456,118; 5,606,133; 5,939,642; 5,817,946; and 6,026,692.

During the compaction process, the gyratory compactor machine records the number of gyratory revolutions, the height of the test specimen (or more accurately, the position or movement of the pressure ram) and other parameters. In order to have consistent and reproducible results from one machine to another, each machine must be calibrated. These calibrations include measurement of the mold angle and measurement of the pressure applied by the pressure ram. Heretofore, the pressure calibration has been typically carried out only in a static mode. For example, a load cell can be temporarily positioned in contact with the pressure ram of the compactor to measure the force applied by the ram. However, a calibration carried out in a static mode will not take into account whether the control system of the gyratory compactor holds the pressure within specifications throughout the entire compaction process. The compaction process is a dynamic process, with the mold being constantly gyrated while pressure is applied. Also, the specimen within the mold is reduced in height as it is compacted. These and other factors can affect the actual pressure applied to the specimen by the gyratory compactor. Thus, there is a need to verify the loading of the gyratory compactor dynamically during the actual gyratory compaction process.

### SUMMARY OF THE INVENTION

The present invention provides a pressure verification device which can be used with a Superpave gyratory compactor to measure the pressure applied to a specimen of asphalt paving mix. The pressure verification device is designed for measuring the pressure within the mold of the gyratory compactor, and to do so dynamically under the actual operating conditions of the gyratory compactor. The gyratory compactor mold is an open-ended cylindrical tubular mold. A pair of disk-shaped end plates are positionable within the cylindrical mold in spaced-apart relation from one another to define an enclosed space within the mold for receiving a sample of asphalt paving mix for compaction by the gyratory compactor. The pressure verification device is positionable within the mold between the end plates for dynamically measuring the pressure exerted upon the sample within the mold.

More particularly, the pressure verification device comprises a rigid disk-shaped plate having opposing opposite surfaces, and at least one pressure transducer carried by this plate on one of its surfaces. The disk-shaped plate preferably has a diameter several times its thickness, and its opposing opposite surfaces are parallel to one another. In a more specific embodiment, the device includes a plurality of pressure transducers carried by the plate at spaced locations with respect to one another. Preferably, each pressure transducer comprises a load cell, with each load cell including a housing and a pressure sensor surface associated with the housing. The pressure sensor surfaces of the respective load cells lie in a common plane. In one specific embodiment, a cable is connected to each load cell for carrying an electrical signal indicative of the pressure sensed by the load cell. In another specific embodiment, the cables are connected to a wireless transmitter configured to wirelessly transmit the signal indicative of the pressure sensed by the load cell.

Thus, embodiments of the present invention are capable of verifying the loading of the gyratory compactor dynamically during the actual gyratory compaction process, thereby providing attendant advantages as detailed herein.

### BRIEF DESCRIPTION OF THE DRAWINGS

Having thus described the invention in general terms, reference will now be made to the accompanying drawings, which are not necessarily drawn to scale, and wherein:

FIG. 1 is an exploded perspective view showing a system for dynamically measuring the pressure within the mold of a gyratory compactor;

FIG. 2 is a cross sectional view showing the pressure verification system installed in a gyratory compactor;

FIG. 3 is a top plan view of a pressure verification device in accordance with the invention;

FIG. 4 is a perspective view thereof;

FIG. 4A is a perspective view of a pressure verification device in accordance with the invention showing the pressure transducers recessed into base plate;

FIG. 5 is a side elevational view of a pressure verification device as shown in FIGS. 3 and 4; and

FIG. 6 is a perspective view of a pressure verification device in accordance with the invention illustrating a wireless device for transmitting electronic signals from the pressure transducers.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The pressure verification device of the present invention is designed to be used with any of the Superpave gyratory compactors which are presently available commercially. Illustrative but non-limiting examples of gyratory compactors which can utilize the pressure verification device of the present invention are described in the following U.S. Pat. Nos. 5,323,655; 5,456,118; 5,606,133; 5,939,642; 5,817,946; and 6,026,692.

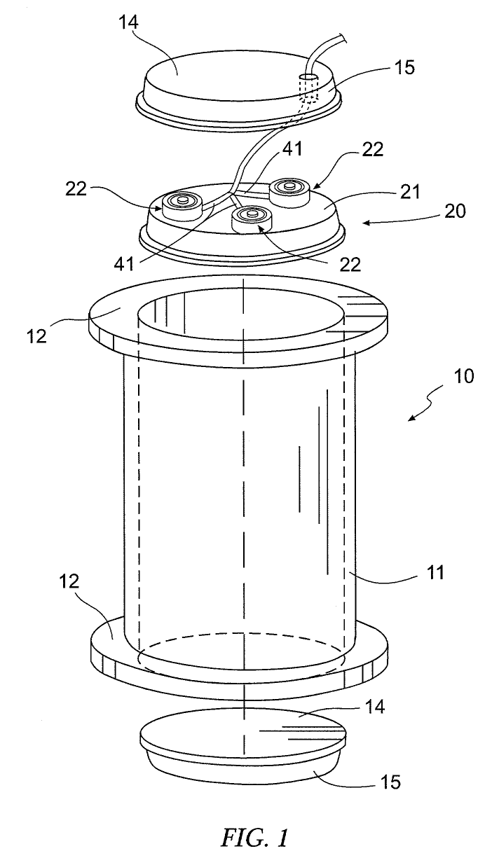

A Superpave gyratory compactor of the type described utilizes a cylindrical mold for producing a cylindrical test specimen from a sample of asphalt paving mix. In FIG. 1, the cylindrical mold is indicated generally by the reference character 10. The mold 10 includes a cylindrical side wall 11 which is of a substantially uniform inner diameter and has open opposite ends. The particular mold 10 illustrated in FIG. 1 has out-turned flanges 12 adjacent the upper and lower ends of the cylindrical wall 11 which provide engagement surfaces cooperating with components of one particular design of a commercially available gyratory compactor apparatus so that the gyratory compactor apparatus can hold the mold and impart a gyratory motion to it. However, some gyratory compactor designs do not require a flanged mold. Therefore, it should be clearly understood that the flanges 12 shown in FIG. 1 are not an essential part of the present invention, and the invention can be operated with other mold designs, including those having a single flange or having no flange, or having other auxiliary elements provided on the mold to cooperate with a particular design of gyratory compactor.

During the compaction process, the open opposite ends of the mold 10 are closed by removable disk-shaped end plates 14 or “pucks” so that pressure can be applied to the specimen of asphalt paving mix located within the mold 10 between the end plates 14. Certain of the commercially available gyratory compactor designs employ two separate and independent end plates 14 which are not physically connected to any part of the gyratory compactor apparatus, and this is the design shown in the accompanying drawings. In other designs (not shown) the end of the compaction ram of the compactor functions as one of the disk-shaped end plates. The pressure verification system and device of the present invention is applicable to both of these variations.

In the embodiment shown, the end plates 14 have an outer diameter corresponding substantially to the inner diameter of the mold 10 so that they will fit loosely within the mold 10 without binding. Preferably, the end plates 14 have a tapered outer wall 15 to accommodate the tilting and gyrating movement of the mold 10. During normal use, when the compactor apparatus is used for producing test specimens, one end plate 14 is placed within the mold 10 to block one end thereof, and then a measured sample of the asphalt paving mix is introduced into the mold 10. Then the opposite end of the mold 10 is closed by placing the second end plate 14 within the mold 10. Then this assembly is placed within a gyratory compactor apparatus, where the end plate 14 at one end of the mold 10 is supported or restrained while a pressure ram is moved into position bearing against the opposite end plate 14 to apply a compaction pressure to the specimen within the mold 10. As the pressure is being applied, the mold 10 is gyrated about an angle of gyration, in accordance with well-known techniques, for example, as disclosed in the aforementioned patents.

For those designs of gyratory compactors which use only a single end plate, rather than a pair, the mold is positioned in the gyratory compactor and either the end of the pressure ram itself is brought into position for applying pressure to the specimen or else an end plate carried by the ram is brought into position.

Since the Superpave gyratory compactor specifications call for the mold 10 to be gyrated at a specified angle, at a specified rpm, and while applying a specified constant pressure, the need arises to calibrate the gyratory compactor apparatus in order to confirm whether the pressure which is applied by the pressure ram meets the Superpave gyratory compactor specifications. Heretofore, this pressure verification has been carried out in a static mode using a load cell or other pressure transducer device connected to the pressure ram. However, this static pressure measurement may not be representative of the pressures encountered in a dynamic mode during actual compaction of a sample when the mold is undergoing gyratory movement. Since the specifications call for applying a constant pressure during the compaction process, it is desirable to be able to verify the actual pressure conditions which exist within the mold during the operation of the gyratory compactor apparatus.

As shown in FIG. 1, the present invention provides a pressure verification device, indicated generally by the reference character 20 which can be placed inside of the mold 10 along with a sample of asphalt paving mix (not shown). The pressure verification device 20 is capable of providing an output signal representative of the actual pressure conditions which exist within the mold 10 during the entire cycle of operation of the compactor apparatus in both static and dynamic modes.

The pressure verification device 20 includes a rigid disk-shaped base plate 21, which may have a configuration similar to that of the end plates 14. Carried by one surface of the base plate 21 is at least one, and preferably a plurality, of pressure transducers 22. The embodiment shown in FIG. 1 has three transducers 22 spaced substantially equidistantly from one another 120° apart and at a substantially uniform radial distance from the center of the base plate 21.

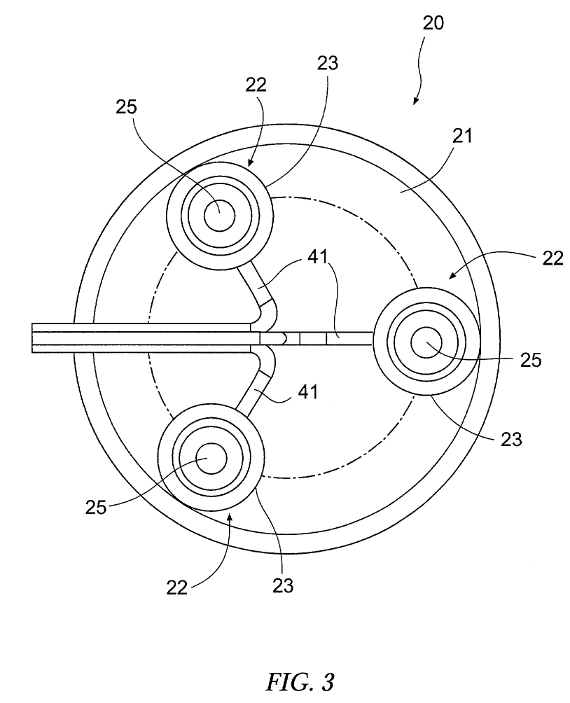

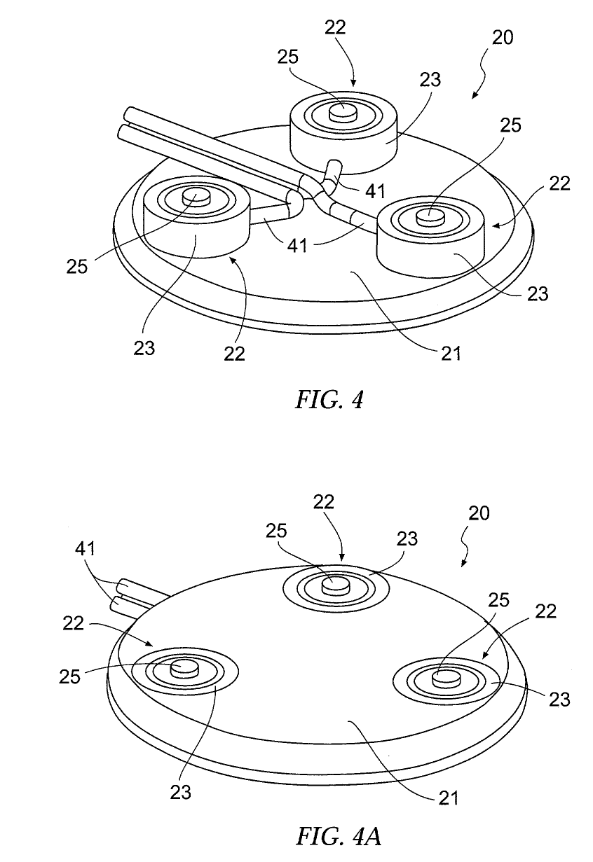

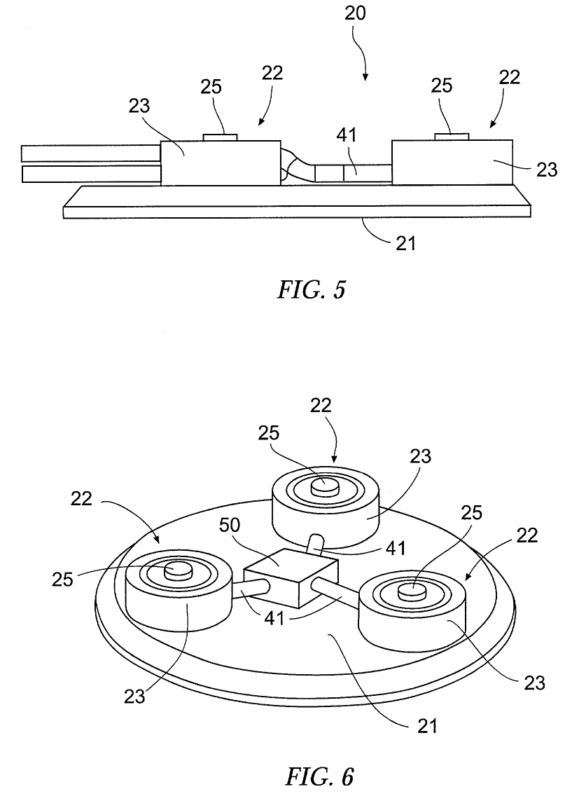

As shown in greater detail in FIGS. 3 to 5, each pressure transducer 22 includes a housing 23 and a load surface or pressure sensing surface 25. The housing 23 is affixed to one surface of the base plate 21. If desired, the housing portion 23 of the transducer can be recessed or partially recessed within the material of the base plate 21, as shown in FIG. 4A. The load surface 25 of each transducer is oriented for receiving pressure in generally the axial direction, i.e., a direction generally perpendicular to the planar surface of the base plate 21.

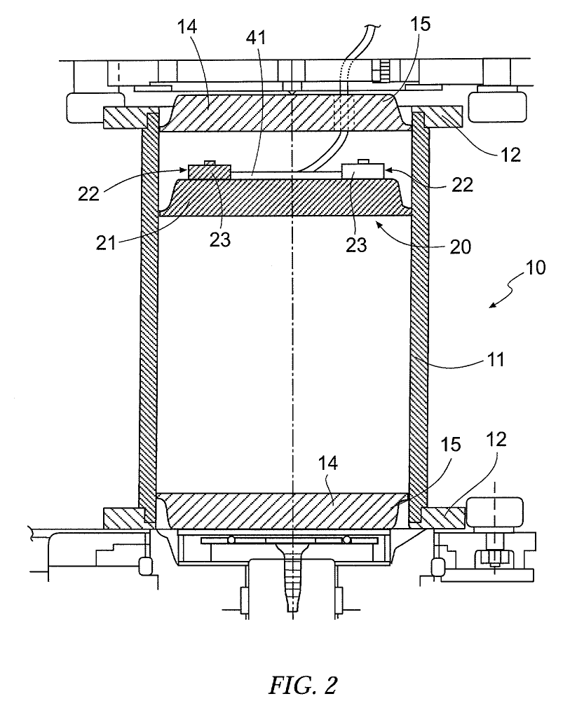

When it is desired to use the device 20 to verify pressure, the mold is filled with a specimen of asphalt paving mix in the conventional manner. Then, the pressure verification device 20 is placed inside the mold 10. Preferably, the pressure transducers 22 are oriented outwardly so that they will come into contact with the inwardly facing surface of an end plate 14. Thus, as shown in FIGS. 1 and 2, a end plate 14 is placed in the open upper end of the mold 10, following insertion of the device 20, so that the load surfaces 25 of the pressure transducers 22 bear against the inwardly facing surface of the end plate 14. Alternatively, in those compactor systems which have an “active puck,” i.e., where pressure is applied to the sample by an end plate attached to the ram or by the end of ram itself, the pressure may be applied directly to the load surfaces 25 of the pressure transducers 22 by the “active puck”. The specimen is then compacted in the conventional manner.

The pressure transducers 22 can employ any conventional pressure sensors. In the embodiment shown, the pressure sensors of the pressure transducers 22 are load cells which generate an output signal proportional to the pressure sensed thereby. Preferably, the load cells are equipped with a temperature compensation circuit which can compensate for changes in resistance due to temperature change. Load cells suitable for use in the present invention are commercially available from a number of sources, such as, for example, Sensotek.

The output signals from the pressure transducers are directed to an electronics unit (not shown) which converts the load cell signals to a pressure value and displays the resulting pressure values on a display device (not shown), such as an LCD display. In the embodiment shown, the output signals are directed via cables 41 to an electronics unit located externally of the mold. However, it is contemplated that all of the components could be integrated into a self-contained verification device or that the signals could be transmitted by a wireless device 50 disposed, for example, on the base plate 21, to a display unit located outside of the mold. In a preferred embodiment, the system utilizes an external electronics unit which includes an output display and appropriate electronics and computational components. The system preferably includes a temperature compensation filter to adjust for changes in the temperature of the load cells while measuring the load. Temperature gradients for the device during a single test may be as large as 280° F., with temperatures ranging from 20 to 300° F.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for dynamically measuring a pressure within a mold of a gyratory compactor, the system comprising:
an open-ended cylindrical tubular mold;
a first and a second disk-shaped end plate, each end plate having a diameter corresponding substantially to the inner diameter of the cylindrical mold, the end plates being positionable in spaced-apart relation within the cylindrical mold so as to define an enclosed space within the mold, the enclosed space being adapted to receive a sample of asphalt paving mix for compaction by the gyratory compactor; and
a pressure verification device positionable within the mold in the enclosed space between the end plates, the pressure verification device being configured to dynamically measure the pressure exerted upon the sample within the mold.

2. A system according to claim 1, wherein the pressure verification device comprises a rigid disk-shaped plate having opposing surfaces, the disk-shaped plate carrying at least one pressure transducer oriented so as to contact a surface of one of the end plates.

3. A system according to claim 2, wherein the rigid disk-shaped plate of the pressure verification device has a diameter and a thickness, with the diameter being multiple times the thickness, and the opposing surfaces thereof are disposed in parallel relation.

4. A system according to claim 2, further comprising a plurality of the pressure transducers carried by the disk-shaped plate on one of the opposing surfaces thereof in spaced apart relation.

5. A system according to claim 4, wherein each pressure transducer comprises a load cell, each load cell including a housing and a pressure sensor surface associated with the housing, the pressure sensor surfaces of the respective load cells lying in a common plane substantially parallel to the one surface of the disk-shaped plate.

6. A system according to claim 5, further comprising a cable in communication with each load cell and extending therefrom for carrying an electrical signal indicative of the pressure sensed by the load cell.

7. A system according to claim 6, further comprising a wireless transmitter in communication with the cables, the wireless transmitter being carried by the disk-shaped plate and being configured to wirelessly transmit the signal indicative of the pressure sensed by the load cell.

8. A system according to claim 1, wherein each of the first and second disk-shaped end plates has a diameter and a thickness, with the diameter being multiple times the thickness, and each of the end plates is discrete.

9. A system according to claim 1, wherein one of the disk-shaped end plates is carried by a pressure ram component of the gyratory compactor.

10. A system for dynamically measuring a pressure within a mold of a gyratory compactor, the system comprising:
a gyratory compactor apparatus;
an open-ended cylindrical tubular mold configured to be operably engageable with the gyratory compactor;
a first and a second disk-shaped end plate, each end plate having a diameter corresponding substantially to the inner diameter of the cylindrical mold, the end plates being positionable in spaced-apart relation within the cylindrical mold so as to define an enclosed space within the mold, the enclosed space being adapted to receive a sample of asphalt paving mix for compaction by the gyratory compactor; and
a pressure verification device positionable within the mold in the enclosed space between the end plates, the pressure verification device being configured to dynamically measure the pressure exerted upon the sample within the mold, the pressure verification device comprising:
a rigid disk-shaped plate having substantially planar opposing surfaces; and
a plurality of load cells carried by the disk-shaped plate on one of the opposing surfaces thereof in spaced apart relation, each load cell including a pressure sensor surface, the pressure sensor surfaces of the respective load cells lying in a common plane substantially parallel to the one surface of the disk-shaped plate.

11. A system according to claim 10, wherein the pressure verification device is oriented such that the pressure sensor surfaces of the load cells are in opposing contacting relation with one of the end plates.

12. A system according to claim 10, further comprising a cable in communication with each load cell and extending therefrom for carrying an electrical signal indicative of the pressure sensed by the load cell.

13. A system according to claim 12, further comprising a wireless transmitter in communication with the cables, the wireless transmitter being carried by the disk-shaped plate and being configured to wirelessly transmit the signal indicative of the pressure sensed by the load cell.

14. A pressure verification device for dynamically measuring a pressure within a cylindrical mold of a gyratory compactor, the device comprising:
a rigid disk-shaped plate having opposing surfaces; and
at least one pressure transducer carried by the disk-shaped plate on one of the opposing surfaces thereof.

15. A device according to claim 14, wherein the rigid disk-shaped plate of the pressure verification device has a diameter and a thickness, with the diameter being multiple times the thickness, and the opposing surfaces thereof are disposed in parallel relation.

16. A device according to claim 14, further comprising a plurality of the pressure transducers carried by the disk-shaped plate on one of the opposing surfaces thereof in spaced apart relation.

17. A device according to claim 16, wherein each pressure transducer comprises a load cell, each load cell including a housing and a pressure sensor surface associated with the housing, the pressure sensor surfaces of the respective load cells lying in a common plane substantially parallel to the one surface of the disk-shaped plate.

18. A device according to claim 17, further comprising a cable in communication with each load cell and extending therefrom for carrying an electrical signal indicative of the pressure sensed by the load cell.

19. A device according to claim 18, further comprising a wireless transmitter in communication with the cables, the wireless transmitter being carried by the disk-shaped plate and being configured to wirelessly transmit the signal indicative of the pressure sensed by the load cell.

20. A device according to claim 17, further comprising three load cells disposed at a 120 degree interval therebetween on the one surface of the disk-shaped plate.

21. A pressure verification device for dynamically measuring a pressure within a cylindrical mold of a gyratory compactor, the device comprising:
a rigid disk-shaped plate having substantially planar opposing surfaces; and
a plurality of load cells carried by the disk-shaped plate on one of the opposing surfaces thereof in spaced apart relation, each load cell including a pressure sensor surface, the pressure sensor surfaces of the respective load cells lying in a common plane substantially parallel to the one surface of the disk-shaped plate.

22. A device according to claim 21, wherein each load cell comprises a housing mounted to the plate, the pressure sensor surface being carried by the housing and configured to sense pressure applied perpendicularly to the common plane.

23. A device according to claim 21, further comprising a cable in communication with each load cell and extending therefrom for carrying an electrical signal indicative of the pressure sensed by the load cell.

24. A device according to claim 23, further comprising a wireless transmitter in communication with the cables, the wireless transmitter being carried by the disk-shaped plate and being configured to wirelessly transmit the signal indicative of the pressure sensed by the load cell.
